(19) United States
(12) Patent Application Publication
(10) Pub. No.: US 2025/0013868 A1
(43) Pub. Date: Jan. 9, 2025

(54) METHOD AND APPARATUS FOR TRAINING MACHINE LEARNING MODEL, DEVICE, AND STORAGE MEDIUM

(71) Applicant: Tencent Technology (Shenzhen) Company Limited, Shenzhen (CN)

(72) Inventors: Xiangting KONG, Shenzhen (CN); Fangying CHEN, Shenzhen (CN)

(21) Appl. No.: 18/895,324

(22) Filed: Sep. 24, 2024

Related U.S. Application Data
(63) Continuation of application No. PCT/CN2023/121052, filed on Sep. 25, 2023.

(30) Foreign Application Priority Data
Dec. 27, 2022 (CN) 202211684867.4

(51) Int. Cl. G06N 3/082; G06N 3/04

(52) U.S. Cl. CPC G06N 3/082; G06N 3/04

(57) ABSTRACT

A method for training a machine learning (ML) model is performed by a computer device, the method including: obtaining classification reference information of a target ML model; determining a type of the ML model according to the classification reference information; when the type of the ML model is a first type, training the ML model by using a hybrid strategy of a model parallelism manner and a data parallelism manner; and when the type of the ML model is a second type, training the ML model by using a strategy of a data parallelism manner, the model parallelism manner being a manner of segmenting a same neural network layer of the ML model to at least two nodes for training, and the data parallelism manner being a manner of allocating different training samples of the ML model to at least two nodes for training.

### CROSS-REFERENCE TO RELATED APPLICATIONS

This application is a continuation application of PCT Patent Application No. PCT/CN2023/121052, entitled “METHOD AND APPARATUS FOR TRAINING MACHINE LEARNING MODEL, DEVICE, AND STORAGE MEDIUM” filed on Sep. 25, 2023, which claims priority to Chinese Patent Application No. 2022116848674, entitled “METHOD AND APPARATUS FOR TRAINING MACHINE LEARNING MODEL, DEVICE, AND STORAGE MEDIUM” and filed with the National Intellectual Property Administration, PRC on Dec. 27, 2022, both of which are incorporated herein by reference in their entirety.

### FIELD OF THE TECHNOLOGY

Embodiments of this application relate to the field of artificial intelligence (AI) technologies, especially, to the field of machine learning (ML) technologies, and in particular, to a method and an apparatus for training an ML model, a device, and a storage medium.

### BACKGROUND OF THE DISCLOSURE

AI is a theory, method, technology, and application system that uses a digital computer or a machine controlled by the digital computer to simulate, extend, and expand human intelligence, perceive an environment, acquire knowledge, and use knowledge to obtain an optimal result. ML is a multi-field interdiscipline, relates to a plurality of disciplines such as the probability theory, statistics, the approximation theory, convex analysis, and the algorithm complexity theory, specializes in studying how a computer simulates or implements a human learning behavior to obtain new knowledge or skills, and reorganize an existing knowledge structure, to keep improving its performance. The ML trains an ML model to enable the ML model to have a prediction capability.

Currently, an ML model is trained through iterations. Each iteration is sequentially performed according to a structure of the ML model. Training the model consumes a lot of time, and training efficiency is low.

### SUMMARY

Embodiments of this application provide a method and an apparatus for training an ML model, a device, and a storage medium.

According to an aspect, a method for training an ML model is performed by a computer device, the method including:
obtaining classification reference information of a target ML model;
determining a type of the ML model according to the classification reference information;
training, when the type of the ML model is a first type, the ML model by using a first parallelism strategy, the first parallelism strategy being a hybrid strategy of a model parallelism manner and a data parallelism manner; and
training, when the type of the ML model is a second type, the ML model by using a second parallelism strategy, the second parallelism strategy being a strategy of a data parallelism manner,
the model parallelism manner being a manner of segmenting a same neural network layer of the ML model to at least two nodes for training, and the data parallelism manner being a manner of allocating different training samples of the ML model to at least two nodes for training.

According to another aspect, a content recommendation method is provided, performed by a computer device, the method including:
obtaining attribute feature information of a target object and attribute feature information of a plurality of contents;
determining, by using a recommendation model, a recommendation score of each of the contents according to the attribute feature information of the target object and the attribute feature information of each of the contents; and
selecting, from the plurality of contents according to the recommendation score of each of the contents, at least one target content recommended to the target object,
the recommendation model being obtained by determining, according to classification reference information of the recommendation model, whether to perform training by using a first parallelism strategy or a second parallelism strategy, the first parallelism strategy being a hybrid strategy of a model parallelism manner and a data parallelism manner, the second parallelism strategy being a strategy of a data parallelism manner, the model parallelism manner being a manner of segmenting a same neural network layer of the ML model to at least two nodes for training, and the data parallelism manner being a manner of allocating different training samples of the ML model to at least two nodes for training.

According to still another aspect, a computer device is provided, including a processor and a memory, the memory having computer-readable instructions stored therein, and the processor being configured to execute the computer-readable instructions to implement the foregoing method for training an ML model or implement the foregoing content recommendation method.

According to still another aspect, a non-transitory computer-readable storage medium is provided, having computer-readable instructions stored therein, the computer-readable instructions being loaded and executed by a processor to implement the foregoing method for training an ML model or implement the foregoing content recommendation method.

Details of one or more embodiments of this application are provided in the accompanying drawings and descriptions below. Other features, objectives, and advantages of this application become apparent from the specification, the drawings, and the claims.

### BRIEF DESCRIPTION OF THE DRAWINGS

To describe the technical solutions in the embodiments of this application more clearly, the following briefly describes the accompanying drawings required for describing the embodiments or the related art. Apparently, the accompanying drawings in the following descriptions show merely some embodiments of this application, and a person of ordinary skill in the art may still derive other drawings from these disclosed accompanying drawings without creative efforts.

FIG. 1 is a schematic diagram of a solution implementation environment according to an embodiment of this application.

FIG. 2 is a flowchart of a method for training an ML model according to an embodiment of this application.

FIG. 3 is a schematic structural diagram of an ML model according to an embodiment of this application.

FIG. 4 is a flowchart of a method for training an ML model according to another embodiment of this application.

FIG. 5 is a flowchart of a method for training an ML model according to another embodiment of this application.

FIG. 6 is a schematic diagram of a training scenario of a recommendation model according to an embodiment of this application.

FIG. 7 is a schematic structural diagram of a fine-ranking model according to an embodiment of this application.

FIG. 8 is a schematic structural diagram of a recommendation model according to another embodiment of this application.

FIG. 9 is a schematic structural diagram of a recommendation model according to another embodiment of this application.

FIG. 10 is a flowchart of a content recommendation method according to an embodiment of this application.

FIG. 11 is a block diagram of an apparatus for training an ML model according to an embodiment of this application.

FIG. 12 is a block diagram of a content recommendation apparatus according to an embodiment of this application.

FIG. 13 is a structural block diagram of a computer device according to an embodiment of this application.

### DESCRIPTION OF EMBODIMENTS

Implementations of this application are further described in detail below with reference to the accompanying drawings.

Before the embodiments of this application are described, some terms involved in this application are explained first.

1. Embedding layer: It is a manner of converting a discrete variable into a continuous vector representation. In neural networks, Embedding is very useful because it can not only reduce a spatial dimension of a discrete variable, but also meaningfully represent the variable.

2. Dense layer: The Dense variable is a commonly used fully-connected Dense variable in deep learning models.

3. Embedding parameter: It is a parameter corresponding to the Embedding layer.

4. Dense parameter: It is a parameter corresponding to the Dense layer.

5. Model parallelism: Computing in deep learning is mainly matrix operations actually. When matrix operations are performed by using a Central Processing Unit (CPU), matrices are stored in an internal memory. If matrix operations are performed by using a Graphics Processing Unit (GPU) card, matrices are stored in a video memory. However, in some case, a matrix is very large, reaching the level of ten million, and then the matrix may be too large to be stored in a video memory. In this case, such a huge matrix has to be split and placed on different GPU cards for computation. A network structure is split from the perspective of a network, and actually the matrix is partitioned from the perspective of a computation process.

6. Data parallelism: Each node has a complete model parameter. Then, nodes take different data, usually a batch_size, and then separately complete forward and backward computation to obtain gradients. These processes of performing training are referred to as workers. In addition to the workers, there is also a parameter server, which is briefly referred to as ps server. These workers send their respective computed gradients to the ps server, and then the ps server performs an update operation, and then sends an updated model back to the nodes. Because data is divided in the parallelism mode, the parallelism mode is referred to as data parallelism.

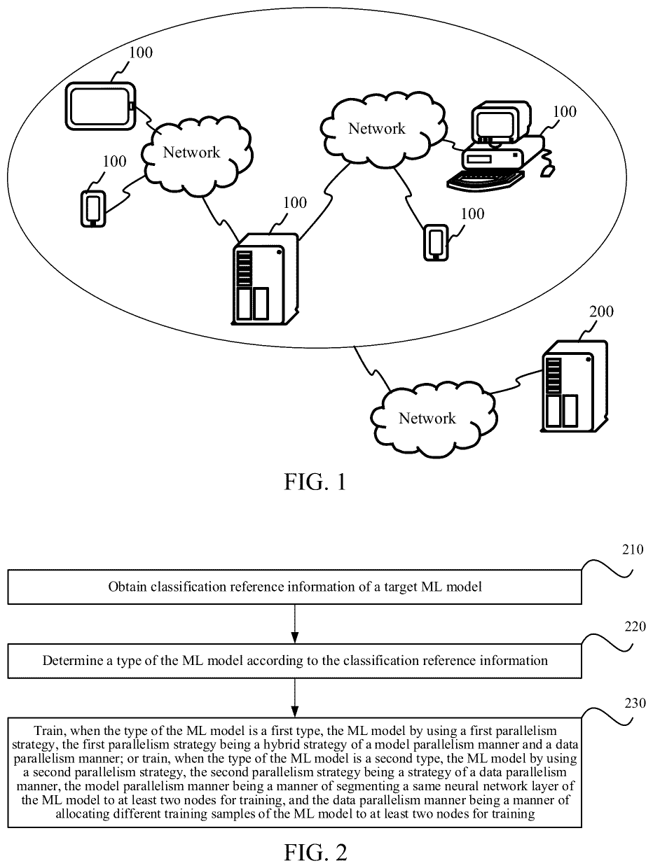

FIG. 1 is a schematic diagram of a solution implementation environment according to an embodiment of this application. The solution implementation environment may be implemented as a system architecture for training of an ML model. The solution implementation environment may include: a node 100 and a computer device 200.

The node 100 is a node configured to train an ML model. A node may be considered as a computer device, a processing unit of the computer device, or a process of the computer device. A node with one ML model or nodes with a plurality of ML models may be maintained in the same computer device. This is not limited in this application.

The computer device 200 is an electronic device with a data computing capability, a data processing capability, and a data storage capability. The computer device may be a terminal device or a server, which is not limited in this application. The terminal device may be an electronic device such as a Personal Computer (PC), a tablet computer, or a mobile phone. In some embodiments, a training framework that runs the ML model may be installed in the training device 100. The training framework may be a training framework that pre-compiles a static network structure, or may be a training framework that illustratively runs a dynamic computing process. This is not limited in this application. The static network structure refers to a network structure that has a fixed connection path between nodes and cannot be changed during running. The dynamic computation process includes a computation graph for forward propagation that is executed immediately. There is no need to wait for a complete computation graph to be created. Each statement dynamically adds a node and an edge to the computation graph, and immediately executes forward propagation to obtain a computation result. The dynamic computation process further includes a computation graph that is destroyed immediately after back propagation, a storage space is released, and the computation graph needs to be reconstructed for a next call. The training framework of the ML model is configured to train the ML model.

The server may be an independent physical server, or may be a server cluster or a distributed system formed by a plurality of physical servers, or may be a cloud server providing cloud computing services. The server may be a back-end server of the foregoing node 100, and is configured to provide a back-end service for the training framework of the ML model.

The node 100 and the computer device 200 may communicate with each other through a network, such as a wired or wireless network.

In a method for training an ML model according to an embodiment of this application, operations may be performed by a computer device. The computer device is an electronic device with a data computing capability, a data processing capability, and a data storage capability. Using the solution implementation environment shown in FIG. 1 as an example, the method for training an ML model may be performed by the node 100, or the method for training an ML model may be performed by the computer device 200, or may be interactively and cooperatively performed by the node 100 and the computer device 200. This is not limited in this application. For ease of description, in the following method embodiments, description is made only using an example in which the operations of the method for training an ML model are performed by a computer device.

For example, the node 100 obtains classification reference information of the ML model. The computer device 200 determines a type of the ML model according to the classification reference information. The computer device 200 trains the node 100 of the ML model according to the type of the ML model, to obtain a trained ML model.

FIG. 2 is a flowchart of a method for training an ML model according to an embodiment of this application. The method includes at least one of the following operations 210 to 230.

Operation 210: Obtain classification reference information of a target ML model.

The ML model is configured to learn a relationship between a data feature and a label in a training phase or learn rules internal to the data feature, so that the ML model can perform prediction based on data external to training in an application phase. A structure and a function of the ML model are not limited in this application. For example, the ML model may be a convolutional neural network model or a fully connected neural network model, which is not limited in this application. For example, the ML model may be a recommendation model, for example, used in video software to recommend videos of interest to a user; or may be an image processing model, for example, used in permission software to recognize a permission of a user corresponding to a collected image. This is not limited in this application.

The classification reference information refers to reference information configured for classifying the ML model. The specific content of the classification reference information is not limited in this application. For example, the classification reference information may be a structure of the ML model, or may be a function of the ML model, or may be an application scenario of the ML model. This is not limited in this application. For example, the classification reference information refers to a structure of the ML model. In this case, the type of the ML model may be determined according to a complexity level of the structure of the ML model. For example, the classification reference information refers to a function of the ML model. In this case, the type of the ML model may be determined according to the function of the ML model.

Operation 220: Determine a type of the ML model according to the classification reference information.

In some embodiments, types of the ML model include a first type and a second type.

In some embodiments, model complexity of the first type of ML model is greater than model complexity of the second type of ML model. The model complexity may be represented by a quantity of parameters. A larger quantity of parameters indicates a larger model complexity, and a smaller quantity of parameters indicates a smaller model complexity. The model complexity may also be represented by a quantity of model layers. A larger quantity of model layers indicates a larger model complexity, and a smaller quantity of model layers indicates a smaller model complexity.

In some embodiments, the first type refers to a large model, which is configured for representing an ML model with a large quantity of parameters or a complex model structure; and the second type refers to a small model, which is configured for representing an ML model with a small quantity of parameters or a simple model structure. In some embodiments, the type of the ML model may be determined according to a parameter quantity threshold. An ML model whose parameter quantity is greater than the parameter quantity threshold is determined as a large model; and an ML model whose parameter quantity is less than the parameter quantity threshold is determined as a small model.

In some embodiments, a parameter quantity of the ML model may be computed according to the classification reference information, and a type of the ML model may be determined according to the parameter quantity of the ML model. For example, the classification reference information is a model structure of the ML model, a parameter quantity of the ML model is estimated according to the model structure of the ML model, and a type of the ML model is determined according to the parameter quantity of the ML model.

In some embodiments, the type of the ML model is determined as the first type when the parameter quantity of the ML model is greater than or equal to a third threshold; and the type of the ML model is determined as the second type when the parameter quantity of the ML model is less than the third threshold. A specific value of the third threshold is not limited in this application, and may be set according to specific implementation. For example, the type of the ML model is determined as the first type when the parameter quantity of the ML model is greater than or equal to 1×10³ G; and the type of the ML model is determined as the second type when the parameter quantity of the ML model is less than 1×10³ G.

In some embodiments, an application scenario of the ML model may be determined according to the classification reference information, and a type of the ML model may be determined according to the application scenario of the ML model. For example, the classification reference information is categories of input data and output data of the ML model, an application scenario of the ML model is determined according to the categories of the input data and the output data of the ML model, and a type of the ML model is determined according to the application scenario of the ML model.

In different application scenarios, types of ML models required are also different. For example, in some application scenarios, since a quantity of parameters that need to be processed is very large and complex, a structure of the ML model is also correspondingly more complex. Therefore, a type of the ML model applied in the application scenario may be determined as the first type. For example, in some application scenarios, since a quantity of parameters that need to be processed is small, a structure of the ML model is correspondingly simple. Therefore, a type of the ML model applied in the application scenario may be determined as the second type.

In some embodiments, the type of the ML model may also be set according to an actual need. For example, a type of the ML model may be inputted while information of the ML model is inputted, and the ML model is trained according to the inputted type of the ML model.

Operation 230: Train, when the type of the ML model is a first type, the ML model by using a first parallelism strategy, the first parallelism strategy being a hybrid strategy of a model parallelism manner and a data parallelism manner; or train, when the type of the ML model is a second type, the ML model by using a second parallelism strategy, the second parallelism strategy being a strategy of a data parallelism manner, the model parallelism manner being a manner of segmenting a same neural network layer of the ML model to at least two nodes for training, and the data parallelism manner being a manner of allocating different training samples of the ML model to at least two nodes for training.

In some embodiments, the first parallelism strategy refers to a hybrid strategy of a model parallelism manner and a data parallelism manner, and training the ML model by using the first parallelism strategy refers to training the ML model by using a hybrid strategy of a model parallelism manner and a data parallelism manner.

In some embodiments, the training the ML model by using the first parallelism strategy includes training at least one neural network layer in the ML model in a model parallelism manner, and training at least one neural network layer of the remaining neural network layers in the ML model in a data parallelism manner.

For example, the computer device may train the first neural network layer included in the ML model in a model parallelism manner, and train the second neural network included in the ML model in a data parallelism manner.

The model parallelism manner refers to a manner of segmenting the same neural network layer of the ML model to at least two nodes for training, that is, each node that participates in the segmentation is segmented to a part of the same neural network layer. The data parallelism manner refers to a manner in which different training samples of the ML model are allocated to at least two nodes for training. In other words, a part of a full quantity of training samples of the ML model is allocated to each node participating in the allocation.

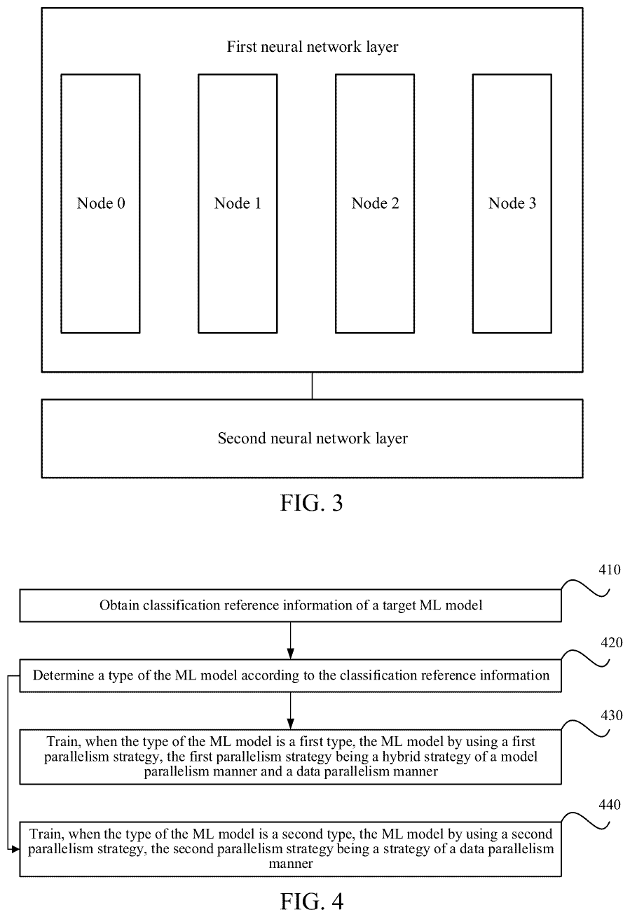

The model parallelism manner refers to segmenting a neural network layer of the ML model to at least two nodes, so that some network parameters of the neural network layer are distributed on each node, and network parameters distributed on the nodes are different. For example, as shown in FIG. 3, a first neural network layer of a neural network model has 4 nodes, where ¼ of network parameters of the first neural network layer is distributed on each of a node 0, a node 1, a node 2, and a node 3.

A segmentation manner of the first neural network layer is not limited in this application. For example, average segmentation may be performed according to the parameter quantity of the network parameters, or group segmentation may be performed according to the categories of the network parameters, or whether to perform average segmentation or group segmentation may be selected according to the parameter quantity of the network parameters. This is not limited in this application.

Specific manners of average segmentation and group segmentation are not limited in this application. For example, average segmentation may be performed on the network parameters of the first neural network layer in a modulo manner. For example, group segmentation may be performed according to the categories of the network parameters of the first neural network layer.

The data parallelism manner refers to a manner in which training samples of the ML model are allocated to at least two nodes for training. A part of a full quantity of training samples is allocated to each of the at least two nodes. A manner of allocating the training samples on the at least two nodes is not limited in this application. The training samples may be averagely allocated to the at least two nodes; or the manner of allocating the training samples may be determined according to computing power corresponding to each of the at least two nodes. For example, 100 training samples are averagely allocated to two nodes, and each node performs training using 50 training samples. For example, among 100 training samples, 60 training samples are allocated to a node 1 with higher computing power, and 40 training samples are allocated to a node 2 with lower computing power.

In some embodiments, network parameters of nodes that performs training in a data parallelism manner are the same.

According to the technical solution provided in this embodiment of this application, ML models are classified, a first type of ML model is trained in the hybrid manner of the model parallelism manner and the data parallelism manner, and a second type of ML model is trained in the data parallelism manner, which can satisfy both training for a large model and training for a small model, thereby satisfying horizontal scalability of training performance of different types of models.

FIG. 4 is a flowchart of a method for training an ML model according to another embodiment of this application. The method may include at least one of the following operations 410 to 440.

Operation 410: Obtain classification reference information of a target ML model.

The specific content of the classification reference information is not limited in this application, and may be set according to actual implementation.

In some embodiments, the classification reference information includes: a structure of the ML model.

In some embodiments, the classification reference information includes: an application scenario of the ML model.

In some embodiments, Related information of the ML model also needs to be obtained, for example, parameters of the ML model, a structure of the ML model, and a function of the ML model need to be obtained.

Operation 420: Determine a type of the ML model according to the classification reference information.

In some embodiments, when the classification reference information is a structure of the ML model, a parameter quantity of the ML model is computed according to the structure of the ML model; the type of the ML model is determined as the first type when the parameter quantity of the ML model is greater than or equal to a third threshold; and the type of the ML model is determined as the second type when the parameter quantity of the ML model is less than the third threshold.

In some embodiments, because some ML models have complex structures and high feature dimensions, a quantity of parameters of the ML models is high. When training is performed in a data parallelism manner, a requirement for related hardware is high and difficult to meet. Therefore, a hybrid parallelism manner needs to be selected for training. Since the structure of the ML model is positively correlated with the parameter quantity of the ML model, the parameter quantity of the ML model may be computed according to the structure of the ML model.

A specific value of the third threshold is not limited in this application, and may be set based on actual implementation, or may be set based on experience. For example, the specific value of the third threshold may be set according to parameters of a device configured to train the ML model. For example, the specific value of the third threshold may be set based on a quantity of parameters of the ML model that needs to be trained.

In some embodiments, when the classification reference information is an application scenario of the structure of the ML model, the type of the ML model is determined as the first type when the application scenario of the ML model belongs to a first scenario category; and the type of the ML model is determined as the second type when the application scenario of the ML model belongs to a second scenario category, where the first scenario category is different from the second scenario category.

Due to different application scenarios, ML models have different structures, functions, and parameter quantities. Therefore, the ML models may be classified according to application scenarios of the ML models, and types of the ML models may be determined. For example, a quantity of parameters of an ML model applied to the first scenario category is different from a quantity of parameters of an ML model applied to the second scenario category.

In some embodiments, the division of the application scenarios is not limited in this application, and may be set according to an actual application scenario of the ML model. For example, When the ML model is a recommendation model, application scenarios of the ML model may be divided into a fine-ranking model, a coarse-ranking model, and a recall model. the fine-ranking model is configured to accurately sort and score a first plurality of candidate recommendation results, the coarse-ranking model is configured to roughly sort and score a second plurality of candidate recommendation results, and the recall model is configured to screen the second plurality of candidate recommendation results from a recommendation dataset. A parameter quantity of the fine-ranking model is clearly higher than a parameter quantity of the coarse-ranking model and a parameter quantity of the recall model. Therefore, the fine-ranking model may be used as the first scenario category, and the coarse-ranking model and the recall model may be used as the second scenario category.

Operation 430: Train, when the type of the ML model is a first type, the ML model by using a first parallelism strategy, the first parallelism strategy being a hybrid strategy of a model parallelism manner and a data parallelism manner.

In some embodiments, when the type of the ML model is the first type, the ML model includes: a first neural network layer using the model parallelism manner, and a second neural network layer using the data parallelism manner.

In some embodiments, input data of the first neural network layer includes first input feature information corresponding to each of M₁ training samples, output data of the first neural network layer includes first output feature information corresponding to each of the M₁ training samples, input data of the second neural network layer includes second input feature information corresponding to each of the M₁ training samples, output data of the second neural network layer includes second output feature information corresponding to each of the M₁ training samples, and M₁ is an integer greater than 1.

The specific value of M₁ is not limited in this application, and may be set according to actual implementation.

The first neural network layer and the second neural network layer are not specifically limited in this application. For example, the first neural network layer may be an embedding layer, and the second neural network layer may be a dense layer (or referred to as a fully connected layer).

In some embodiments, the training the ML model by using a first parallelism strategy includes: for the first neural network layer, segmenting the first neural network layer into N₁ segments and synchronizing network parameters of the N₁ segments to N₁ nodes, where an i^{th} node in the N₁ nodes stores a network parameter of an i^{th} segment in the N₁ segments, N₁ is an integer greater than 1, and i is a positive integer less than or equal to N₁; for the i^{th} node, processing the first input feature information corresponding to each of the M₁ training samples through the i^{th} segment, to obtain an i^{th} feature component corresponding to each of the M₁ training samples, where M₁ is an integer greater than 1; and aggregating N₁ feature components corresponding to each of the M₁ training samples, to obtain the first output feature information corresponding to each of the M₁ training samples.

The value of N₁ is not limited in this application, and may be set according to actual implementation. For example, the value is set according to the parameter quantity of the network parameters of the first neural network layer.

A manner of segmenting the first neural network layer into the N₁ segments is not limited in this application. For example, the segmentation may be performed according to the feature categories respectively corresponding to the network parameters of the first neural network layer.

In some embodiments, the network parameters of the first neural network layer include network parameters respectively corresponding to a plurality of features. The segmenting the first neural network layer into N₁ segments and synchronizing network parameters of the N₁ segments to N₁ nodes includes: processing the network parameters respectively corresponding to the plurality of features to obtain feature values respectively corresponding to the plurality of features; performing a modulo operation on each of the feature values respectively corresponding to the plurality of features and N₁ to obtain modulus values respectively corresponding to the plurality of features; allocating network parameters corresponding to features of a same modulus value to a same segment, to obtain the network parameters of the N₁ segments; and synchronizing the network parameters of the N₁ segments to the N₁ nodes.

The network parameters respectively corresponding to the plurality of features may be considered as matrices respectively corresponding to the plurality of features. The feature values refer to solutions respectively corresponding to the network parameters respectively corresponding to the plurality of features, and may be represented as feature_value.

The modulo operation refers to finding a remainder between a feature value corresponding to each of the plurality of features and N₁, and may be represented as feature_value % N₁.

By performing segmentation through the foregoing method, a quantity of parameters on each segment obtained is balanced, and each node fully participates in parallel processing, thereby improving training efficiency.

In some embodiments, the segmenting the first neural network layer into N₁ segments and synchronizing network parameters of the N₁ segments to N₁ nodes includes: determining a feature category corresponding to each network parameter of the first neural network layer; allocating network parameters corresponding to a same feature category to a same segment, to obtain the network parameters of the N₁ segments; and synchronizing the network parameters of the N₁ segments to the N₁ nodes.

The feature categories respectively corresponding to the network parameters of the first neural network layer are not limited in this application. The feature categories may be set according to a function of the target ML model, an application scenario, and the like. For example, When the ML model is a video recommendation model, the feature categories may include an age, a gender, a position, an interest, a user identifier, and the like. For example, a network parameter corresponding to the age feature may be segmented to an i^{th} segment, and a network parameter corresponding to the gender feature may be segmented to an (i+1)^{th} segment.

The network parameters of the first neural network layer are sliced through the foregoing method, which can save traffic and reduce resource consumption of the computer device.

In some embodiments, the network parameters of the first neural network layer include network parameters respectively corresponding to a plurality of features. A parameter quantity of network parameters corresponding to some features is large, and a parameter quantity of network parameters corresponding to some features is small. Therefore, for network parameters corresponding to features with a large parameter quantity, the foregoing two slicing methods may be fused.

In some embodiments, the segmenting the first neural network layer into N₁ segments and synchronizing network parameters of the N₁ segments to N₁ nodes includes: slicing, for network parameters with a parameter quantity less than a first threshold in the network parameters respectively corresponding to the plurality of features, the network parameters according to feature categories corresponding to the network parameters, to obtain first network sub-parameters respectively corresponding to the N₁ segments; determining, for network parameters with a parameter quantity greater than or equal to the first threshold in the network parameters respectively corresponding to the plurality of features, feature values of the network parameters; performing a modulo operation on the feature values of the network parameters and N₁, to obtain modulus values of the network parameters; and obtaining, according to the modulus values of the network parameters, second network sub-parameters respectively corresponding to the N₁ segments; obtaining network parameters of the N₁ segments according to the first network sub-parameters respectively corresponding to the N₁ segments and the second network sub-parameters respectively corresponding to the N₁ segments; and synchronizing the network parameters of the N₁ segments to the N₁ nodes.

The value of the first threshold is not limited in this application, and may be set according to actual implementation.

Through the foregoing method, the network parameters of the first neural network layer are sliced, which can balance the quantities of parameters of the nodes while reducing traffic, thereby fully performing parallel processing and improving training efficiency.

In some embodiments, for the second neural network layer, network parameters of the second neural network layer are synchronized to N₂ nodes, and the M₁ training samples are divided into N₂ sample sets, where each sample set includes at least one training sample, a j^{th} node in the N₂ nodes is configured to process a j^{th} sample set in the N₂ sample sets, N₂ is an integer greater than 1, and j is a positive integer less than or equal to N₂;
for the j^{th} node, second input feature information corresponding to each training sample in the j^{th} sample set is processed through the j^{th} node by using the second neural network layer, to obtain second output feature information corresponding to each training sample in the j^{th} sample set; and second output feature information corresponding to each of training samples in the N₂ sample sets is aggregated, to obtain the second output feature information corresponding to each of the M₁ training samples.

The value of N₂ is not limited in this application, and may be set according to actual implementation.

The second neural network layer may be trained before the first neural network layer, or may be trained after the first neural network layer. This is not limited in this application. Values of N₁ and N₂ may be the same or different, which is not limited in this application.

The method for dividing the M₁ training samples into N₂ sample sets is not limited in this application. For example, the M₁ training samples may be randomly divided into N₂ sample sets, or the M₁ training samples may be averagely divided into N₂ sample sets.

In some embodiments, for the j^{th} node, a network parameter of the j^{th} node is updated according to the second output feature information corresponding to each training sample in the j^{th} sample set, to obtain an updated network parameter of the j¹ node; updated network parameters respectively corresponding to the N₂ nodes are synchronized, to obtain updated network parameters of the second neural network layer; and the network parameters of the N₁ nodes are updated according to the second output feature information corresponding to each of the M₁ training samples, to obtain updated network parameters respectively corresponding to the N₁ nodes.

In some embodiments, a loss of the j^{th} sample set is computed according to the second output feature information corresponding to each training sample in the j^{th} sample set, a gradient of the j^{th} sample set is determined based on the loss of the j^{th} sample set, and The network parameter of the j^{th} node is updated according to the gradient of the j^{th} sample set, to obtain an updated network parameter of the j^{th} node.

The method for synchronizing the updated network parameters respectively corresponding to the N₂ nodes is not limited in this application. For example, the updated network parameters respectively corresponding to the N₂ nodes are synchronized may be synchronized using an ALLReduce algorithm, to obtain updated network parameters of the second neural network layer.

Operation 440: Train, when the type of the ML model is a second type, the ML model by using a second parallelism strategy, the second parallelism strategy being a strategy of a data parallelism manner.

In some embodiments, the training the ML model by using a second parallelism strategy includes: synchronizing network parameters of the ML model to N₃ nodes, and dividing M₂ training samples of the ML model into N₃ sample sets, where each sample set includes at least one training sample, a k^{th} node in the N₃ nodes is configured to process a k^{th} sample set in the N₃ sample sets, N₃ is an integer greater than 1, and k is a positive integer less than or equal to N₃; for the k^{th} node, processing, through the k^{th} node, each training sample in the k^{th} sample set by using the ML model, to obtain a prediction result corresponding to each training sample in the k^{th} sample set; and obtaining, according to the prediction result corresponding to each training sample in the k^{th} sample set, a parameter adjustment gradient determined by the k^{th} node; aggregating parameter adjustment gradients determined respectively by the N₃ nodes, to obtain a parameter adjustment gradient of the ML model; and adjusting the network parameters of the ML model according to the parameter adjustment gradient of the ML model, to obtain the trained ML model.

The method for dividing the M₂ training samples into N₃ sample sets is not limited in this application. For example, the M₂ training samples may be randomly divided into N₃ sample sets, or the M₂ training samples may be averagely divided into N₃ sample sets.

The values of M₂ and N₃ are not limited in this application, and may be set according to actual implementation.

In some embodiments, a loss corresponding to the k^{th} sample set is computed according to the prediction result corresponding to each training sample in the k^{th} sample set, and a parameter adjustment gradient determined by the k^{th} node is obtained according to the loss corresponding to the k^{th} sample set.

The method for aggregating the parameter adjustment gradients determined respectively by the N₃ nodes is not limited in this application. For example, the parameter adjustment gradients determined respectively by the N₃ nodes are aggregated by using an ALLReduce method.

In some embodiments, the training the ML model by using a second parallelism strategy includes: synchronizing network parameters of the ML model to N₃ nodes, and dividing M₃ training samples of the ML model into N₄ sample sets, where each sample set includes at least one training sample, N₄ is a times N₃, a p^{th} node in the N₃ nodes is configured to process a sample sets in the N₄ sample sets, N₃ is an integer greater than 1, p is a positive integer less than or equal to N₃, N₄ is an integer greater than 1, and a is an integer greater than 1; for the p^{th} node, processing, through the p^{th} node, each training sample in the α sample sets by using the ML model, to obtain a prediction result corresponding to each training sample in the α sample sets; obtaining, according to the prediction result corresponding to each training sample in the α sample sets, a parameter adjustment sub-gradients determined by the p^{th} node; accumulating, when a quantity of sample sets processed by the p^{th} node is less than a second threshold, the α parameter adjustment sub-gradients determined by the p^{th} node, to obtain a parameter adjustment gradient determined by the p^{th} node; aggregating, when a quantity of sample sets processed by the p^{th} node reaches the second threshold, parameter adjustment gradients determined respectively by the N₃ nodes, to obtain a parameter adjustment gradient of the ML model; and adjusting the network parameters of the ML model according to the parameter adjustment gradient of the ML model, to obtain the trained ML model.

The value of N₄ is not limited in this application, and may be set according to actual implementation.

The value of the second threshold is not limited in this application, and may be set according to actual implementation.

In some embodiments, the value of the second threshold may be set according to computing power of a device that trains the ML model.

In some embodiments, the value of the second threshold may be dynamically adjusted during training. For example, the value of the second threshold is adjusted according to a time period.

In some embodiments, the second threshold may alternatively be a fixed value set before training starts.

The neural network model is trained through the foregoing method, so that traffic required in a training process can be reduced.

According to the technical solution provided in this embodiment of this application, the first type of neural network model is trained in the model parallelism manner, and the second type of neural network model is trained in the data parallelism manner. This can give consideration to both horizontal scalability of training performance of a large model and horizontal scalability of training performance of a small model, reduce learning costs of a user, improve model compatibility, and finally improve model training efficiency. A computation manner of local gradient accumulation is further introduced into the data parallelism manner, which can greatly reduce traffic and improve scalability of model training.

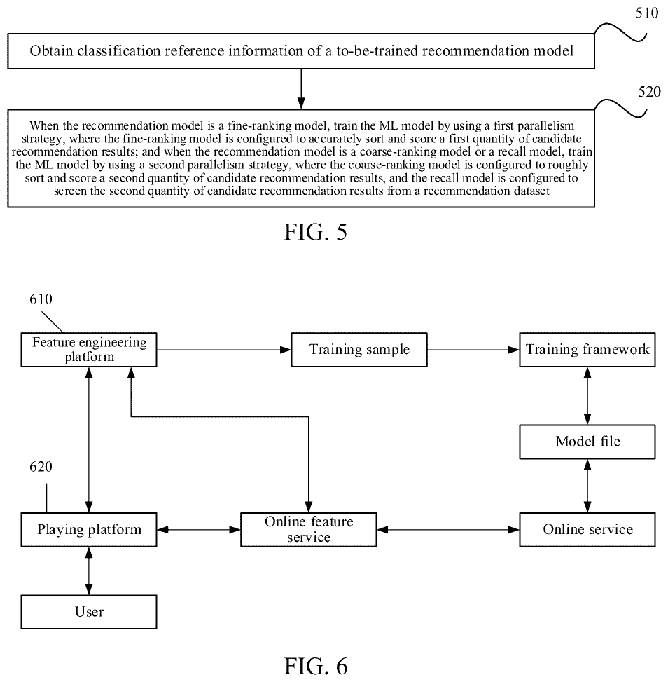

FIG. 5 is a flowchart of a method for training an ML model according to an embodiment of this application. The method may include at least one of the following operations 510 to 520.

An example in which the ML model is a recommendation model is used. The ML model is a recommendation model. when the ML model is a fine-ranking model, the type of the ML model is the first type, where the fine-ranking model is configured to accurately sort and score a first plurality of candidate recommendation results; and when the ML model is a coarse-ranking model or a recall model, the type of the ML model is the second type, where the coarse-ranking model is configured to roughly sort and score a second plurality of candidate recommendation results, and the recall model is configured to screen the second plurality of candidate recommendation results from a recommendation dataset.

Operation 510: Obtain classification reference information of a to-be-trained recommendation model.

For example, as shown in FIG. 6, the recommendation model is a video recommendation model, and a training framework obtains classification reference information of the recommendation model.

For example, the classification reference information is an application scenario of the recommendation model. For example, the classification reference information is whether the recommendation model is a fine-ranking model, a coarse-ranking model, or a recall model.

Operation 520: When the recommendation model is a fine-ranking model, train the ML model by using a first parallelism strategy, where the fine-ranking model is configured to accurately sort and score a first plurality of candidate recommendation results; and when the recommendation model is a coarse-ranking model or a recall model, train the ML model by using a second parallelism strategy, where the coarse-ranking model is configured to roughly sort and score a second plurality of candidate recommendation results, and the recall model is configured to screen the second plurality of candidate recommendation results from a recommendation dataset.

In some embodiments, the first quantity and the second quantity may be the same or different. For example, the first quantity may be less than the second quantity. For example, the first quantity may be equal to the second quantity.

In some embodiments, the fine-ranking model includes: a first neural network layer using the model parallelism manner, and a second neural network layer using the data parallelism manner, where input data of the first neural network layer includes first input feature information corresponding to each of M₁ training samples, output data of the first neural network layer includes first output feature information corresponding to each of the M₁ training samples, input data of the second neural network layer includes second input feature information corresponding to each of the M₁ training samples, output data of the second neural network layer includes second output feature information corresponding to each of the M₁ training samples, and M₁ is an integer greater than 1.

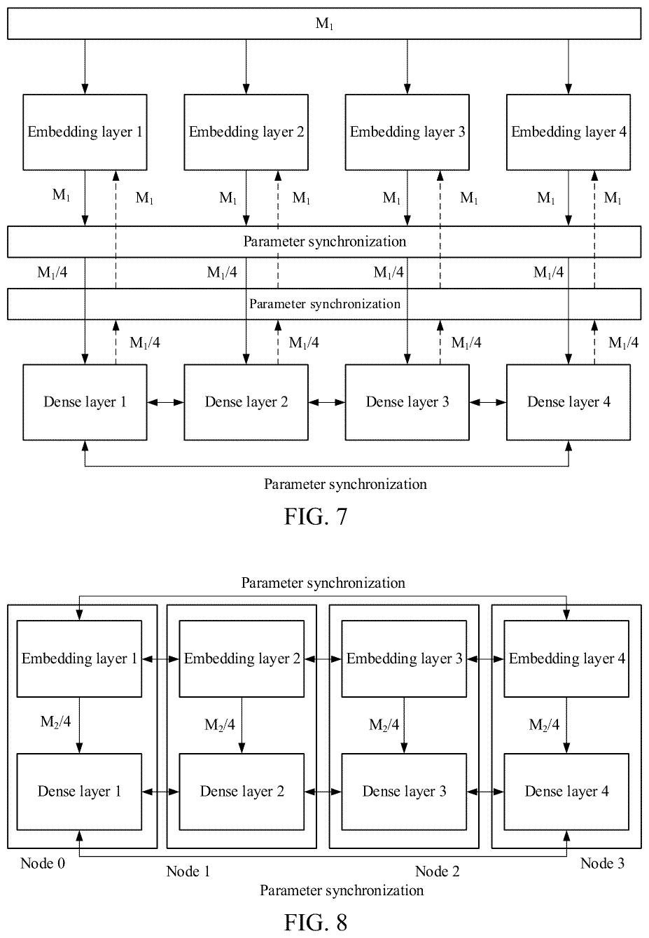

For example, as shown in FIG. 7, the first neural network layer is an embedding layer (Embedding), and the second neural network layer is a dense layer (Dense model).

For the embedding layer, the embedding layer is segmented into N₁ segments and network parameters of the N₁ segments are synchronized to N₁ nodes, where an i^{th} node in the N₁ nodes stores a network parameter of an i^{th} segment in the N₁ segments, N₁ is an integer greater than 1, and i is a positive integer less than or equal to N₁; for the i^{th} node, the first input feature information corresponding to each of the M₁ training samples is processed through the i^{th} segment, to obtain an i^{th} feature component corresponding to each of the M₁ training samples, where M₁ is an integer greater than 1; and N₁ feature components corresponding to each of the M₁ training samples are aggregated, to obtain the first output feature information corresponding to each of the M₁ training samples.

For the dense layer, network parameters of the dense layer are synchronized to N₂ nodes, and the M₁ training samples are divided into N₂ sample sets, where each sample set includes at least one training sample, a j^{th} node in the N₂ nodes is configured to process a j^{th} sample set in the N₂ sample sets, N₂ is an integer greater than 1, and j is a positive integer less than or equal to N₂; for the j^{th} node, second input feature information corresponding to each training sample in the j^{th} sample set is processed through the j^{th} node by using the dense layer, to obtain second output feature information corresponding to each training sample in the j^{th} sample set; and second output feature information corresponding to each of training samples in the N₂ sample sets is aggregated, to obtain the second output feature information corresponding to each of the M₁ training samples.

For example, as shown in FIG. 7, For the embedding layer, the embedding layer is segmented into 4 segments and network parameters of the 4 segments are synchronized to 4 nodes, where an i^{th} node in the 4 nodes stores a network parameter of an i^{th} segment in the N₁ segments; for the i^{th} node, the first input feature information corresponding to each of the M₁ training samples is processed through the i^{th} segment, to obtain an i^{th} feature component corresponding to each of the M₁ training samples, where M₁ is an integer greater than 1; and 4 feature components corresponding to each of the M₁ training samples are aggregated (parameters are synchronized), to obtain the first output feature information corresponding to each of the M₁ training samples.

For the dense layer, network parameters of the dense layer are synchronized to 4 nodes, and the M₁ training samples are divided into 4 sample sets, where each sample set includes M₁/4 training samples, a j^{th} node in the 4 nodes is configured to process a j^{th} sample set in the 4 sample sets; for the j^{th} node, second input feature information corresponding to each training sample in the j^{th} sample set is processed through the j^{th} node by using the dense layer, to obtain second output feature information corresponding to each training sample in the j^{th} sample set; and second output feature information corresponding to each of training samples in the 4 sample sets is aggregated (parameters are synchronized), to obtain the second output feature information corresponding to each of the M₁ training samples.
for the j^{th} node, a network parameter of the j^{th} node is updated according to the second output feature information corresponding to each training sample in the j^{th} sample set, to obtain an updated network parameter of the j^{th} node; updated network parameters respectively corresponding to the 4 nodes (dense layers) are synchronized, to obtain updated network parameters of the dense layer; and the network parameters of the 4 nodes (embedding layers) are updated according to the second output feature information corresponding to each of the M₁ training samples, to obtain updated network parameters respectively corresponding to the 4 nodes (the embedding layers).

In some embodiments, the coarse-ranking model or the recall model is trained by using the following method.

Network parameters of the recommendation model are synchronized to N₃ nodes, and M₂ training samples of the recommendation model are divided into N₃ sample sets, where each sample set includes at least one training sample, a k^{th} node in the N₃ nodes is configured to process a k^{th} sample set in the N₃ sample sets, N₃ is an integer greater than 1, and k is a positive integer less than or equal to N₃; for the k^{th} node, each training sample in the k^{th} sample set is processed through the k^{th} node by using the recommendation model, to obtain a prediction result corresponding to each training sample in the k^{th} sample set; and a parameter adjustment gradient determined by the k^{th} node is obtained according to the prediction result corresponding to each training sample in the k^{th} sample set; parameter adjustment gradients determined respectively by the N₃ nodes are aggregated, to obtain a parameter adjustment gradient of the recommendation model; and the network parameters of the recommendation model are adjusted according to the parameter adjustment gradient of the recommendation model, to obtain the trained recommendation model.

For example, as shown in FIG. 8, network parameters of the recommendation model are synchronized to 4 nodes, where each node includes one embedding layer and one dense layer, and the M₂ training samples of the recommendation model are divided into 4 sample sets, where each sample set includes M₂/4 training samples, a k^{th} node in the 4 nodes is configured to process a k^{th} sample set in the 4 sample sets; for the k^{th} node, each training sample in the k^{th} sample set is processed through the k^{th} node by using the recommendation model, to obtain a prediction result corresponding to each training sample in the k^{th} sample set; and a parameter adjustment gradient determined by the k^{th} node is obtained according to the prediction result corresponding to each training sample in the k^{th} sample set; parameter adjustment gradients determined respectively by the 4 nodes are aggregated (parameters are synchronized), to obtain a parameter adjustment gradient of the recommendation model; and the network parameters of the recommendation model are adjusted according to the parameter adjustment gradient of the recommendation model, to obtain the trained recommendation model.

In some embodiments, the coarse-ranking model or the recall model is trained by using the following method.

Network parameters of the recommendation model are synchronized to N₃ nodes, and M₃ training samples of the recommendation model are divided into N₄ sample sets, where each sample set includes at least one training sample, N₄ is a times N₃, a p^{th} node in the N₃ nodes is configured to process α sample sets in the N₄ sample sets, N₃ is an integer greater than 1, p is a positive integer less than or equal to N₃, N₄ is an integer greater than 1, and a is an integer greater than 1; for the p^{th} node, each training sample in the α sample sets is processed through the p^{th} node by using the recommendation model, to obtain a prediction result corresponding to each training sample in the α sample sets; a parameter adjustment sub-gradients determined by the p^{th} node are obtained according to the prediction result corresponding to each training sample in the α sample sets; when a quantity of sample sets processed by the p^{th} node is less than a second threshold, the α parameter adjustment sub-gradients determined by the p^{th} node are accumulated, to obtain a parameter adjustment gradient determined by the p^{th} node; when a quantity of sample sets processed by the p^{th} node reaches the second threshold, parameter adjustment gradients determined respectively by the N₃ nodes are aggregated, to obtain a parameter adjustment gradient of the recommendation model; and the network parameters of the recommendation model are adjusted according to the parameter adjustment gradient of the recommendation model, to obtain the trained recommendation model.

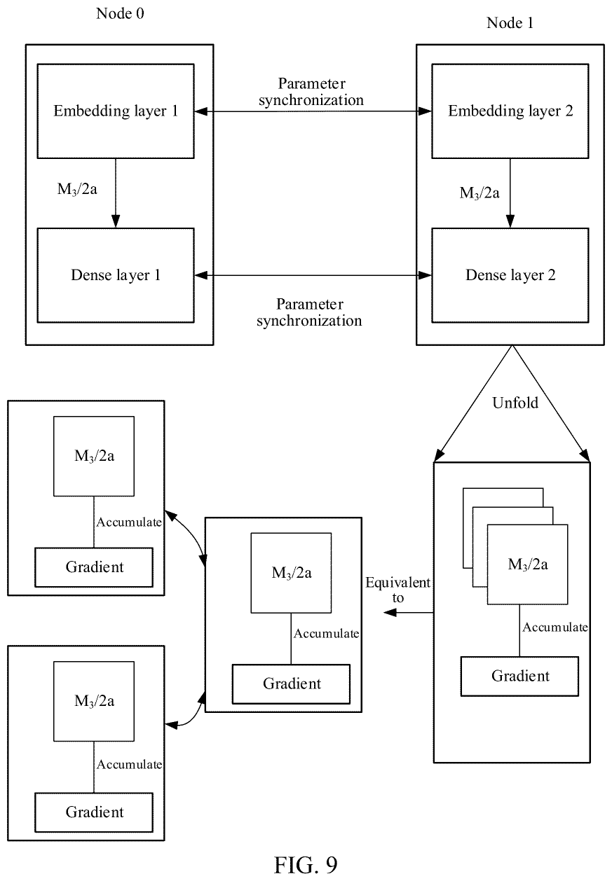

For example, as shown in FIG. 9, Network parameters of the recommendation model are synchronized to 2 nodes, and M₃ training samples of the recommendation model are divided into N₄ sample sets, where each sample set includes at least one training sample, N₄ is a times 2, a p^{th} node in the 2 nodes is configured to process α sample sets in the N₄ sample sets, N₄ is an integer greater than 1, and a is an integer greater than 1; for the p^{th} node, each training sample in the α sample sets is processed through the p^{th} node by using the recommendation model, to obtain a prediction result corresponding to each training sample in the α sample sets; a parameter adjustment sub-gradients determined by the p^{th} node are obtained according to the prediction result corresponding to each training sample in the α sample sets; when a quantity of sample sets processed by the p^{th} node is less than a second threshold, the α parameter adjustment sub-gradients determined by the p^{th} node are accumulated, to obtain a parameter adjustment gradient determined by the p^{th} node; when a quantity of sample sets processed by the p^{th} node reaches the second threshold, parameter adjustment gradients determined respectively by the 2 nodes are aggregated (parameters are synchronized), to obtain a parameter adjustment gradient of the recommendation model; and the network parameters of the recommendation model are adjusted according to the parameter adjustment gradient of the recommendation model, to obtain the trained recommendation model.

For example, if a value of the second threshold is 3, when a quantity of sample sets processed by the p^{th} node is less than 3, the α parameter adjustment sub-gradients determined by the p^{th} node are accumulated, to obtain a parameter adjustment gradient determined by the p^{th} node; and when a quantity of sample sets processed by the p^{th} node reaches 3, parameter adjustment gradients determined respectively by the 2 nodes are aggregated, to obtain a parameter adjustment gradient of the recommendation model.

A trained recommendation model, as shown in FIG. 6, may be configured for an online service. A feature engineering platform 610 collects data of a user at a playing platform 620 as a training sample to train the recommendation model, to obtain a trained recommendation model that is configured for an online feature service for the playing platform 620 to predict information such as a click-through rate, a conversion rate, a user duration, and the like of the user.

According to the technical solution provided in this embodiment of this application, the fine-ranking model is trained in a hybrid parallelism manner, and the coarse-ranking model or the recall model is trained in a data parallelism manner, which can give consideration to horizontal scalability of training performance of the fine-ranking model, the coarse-ranking model, and the recall model.

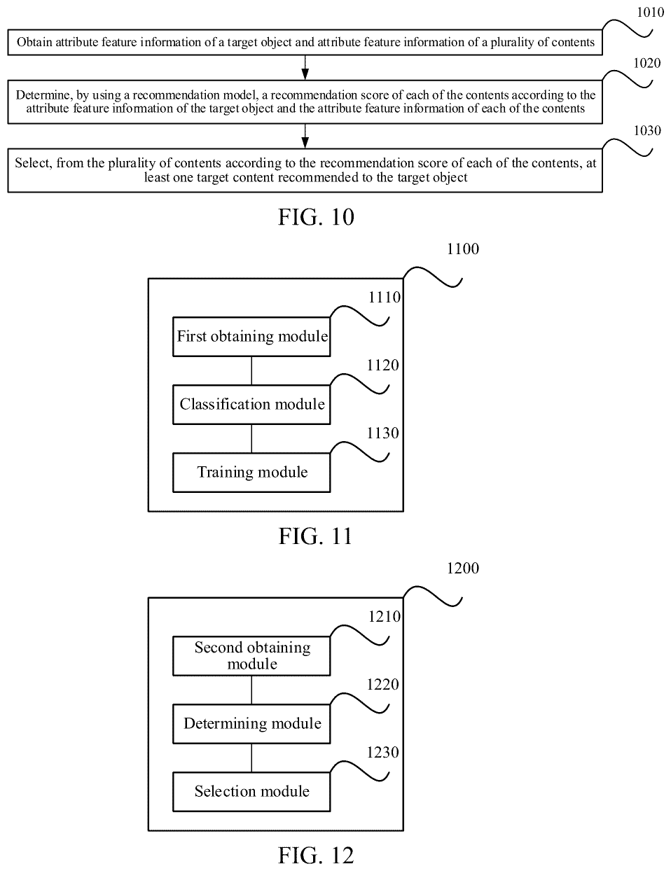

FIG. 10 is a flowchart of a content recommendation method according to an embodiment of this application. The method may include at least one of the following operations 1010 to 1030.

Operation 1010: Obtain attribute feature information of a target object and attribute feature information of a plurality of contents.

Operation 1020: Determine, by using a recommendation model, a recommendation score of each of the contents according to the attribute feature information of the target object and the attribute feature information of each of the contents.

Operation 1030: Select, from the plurality of contents according to the recommendation score of each of the contents, at least one target content recommended to the target object.

The recommendation model is obtained by determining, according to classification reference information of the recommendation model, whether to perform training by using a first parallelism strategy or a second parallelism strategy, the first parallelism strategy is a hybrid strategy of a model parallelism manner and a data parallelism manner, the second parallelism strategy is a strategy of a data parallelism manner, the model parallelism manner is a manner of segmenting a same neural network layer of the ML model to at least two nodes for training, and the data parallelism manner is a manner of allocating different training samples of the ML model to at least two nodes for training.

A scenario to which the recommendation model is applied is not limited in this application. For example, the recommendation model may be a video recommendation model. For example, the recommendation model is applied to a short video platform to recommend a video of interest to a user. For example, the recommendation model may alternatively be a commodity recommendation model. For example, the recommendation model is applied to a shopping platform to recommend commodities of interest to a user. For example, the recommendation model may alternatively be a book recommendation model. For example, the recommendation model is applied to a reading platform to recommend a book of interest to a user.

In some embodiments, the recommendation model may be a recall model, a coarse-ranking model, or a fine-ranking model, which is not limited in this application.

The attribute feature information of the target object is not limited in this application. For example, For the video recommendation model, the attribute feature information of the target object may be feature information of a video added to the favorites by the user, feature information of a video to which the user gives a like, feature information of an account followed by the user, or the like. For example, For the book recommendation model, the attribute feature information of the target object may be feature information of a book read by the user, feature information of a book added to the favorites by the user, or the like.

The attribute feature information of the content is not limited in this application. For example, For the video recommendation model, the attribute feature information of the content may be attribute feature information of a video, for example, a type of the video (funning, dancing, song, food, or the like), or a release time of the video (released in recent 24 hours, released in recent a week, or the like). For example, For the book recommendation model, the attribute feature information of the content may be a book type (novel, prose, essay, or the like), a book status (being serialized, completed, update-ceased temporarily, or the like), a book score, or the like.

A specific structure of the recommendation model is not limited in this application. For example, the recommendation model may be a neural network model, for example, a convolutional neural network model or a recurrent neural network model.

A determination condition of the target content is not limited in this application.

In some embodiments, Content with a recommendation score higher than a score threshold may be determined as the target content according to a recommendation score of each content.

In some embodiments, Content with a recommendation score ranking higher than a ranking threshold may be selected and determined as the target content according to a recommendation score of each content.

The score threshold and the ranking threshold may be set according to actual implementation, which is not limited in this application.

When the recommendation model is a video recall model, attribute feature information of the user and attribute feature information of a plurality of videos are obtained; recommendation scores of the videos are determined according to the attribute feature information of the user and the attribute feature information of the videos by using the video recall model; and at least one target video recommended to the user is selected from the plurality of videos according to the recommendation scores of the videos. The plurality of videos may be all videos or some videos in a resource pool of a video platform to which the recall model is applied.

When the recommendation model is a video coarse-ranking model, attribute feature information of the user and attribute feature information of a plurality of videos are obtained; recommendation scores of the videos are determined according to the attribute feature information of the user and the attribute feature information of the videos by using the video recall model; and at least one target video recommended to the user is selected from the plurality of videos according to the recommendation scores of the videos. The plurality of videos may be at least one target video obtained by the recall model. The at least one target video obtained by the video coarse-ranking model may be arranged according to recommendation scores.

When the recommendation model is a video fine-ranking model, attribute feature information of the user and attribute feature information of a plurality of videos are obtained; recommendation scores of the videos are determined according to the attribute feature information of the user and the attribute feature information of the videos by using the video recall model; and at least one target video recommended to the user is selected from the plurality of videos according to the recommendation scores of the videos. The plurality of videos may be at least one target video obtained by the coarse-ranking model. The at least one target video obtained by the video fine-ranking model may be arranged according to recommendation scores. The accuracy of the recommendation score obtained by the video fine-ranking model is higher than that of the recommendation score obtained by the video coarse-ranking model. The processing efficiency of the video coarse-ranking model is higher than that of the video fine-ranking model.

According to the technical solution provided in this embodiment of this application, through the method for training an ML model, a recommendation model is obtained through training. The recommendation model can determine, according to the attribute feature information of the target object and the attribute feature information of each content, the target content to be recommended to the target object.

The following is apparatus embodiments of this application, which may be used to perform the method embodiments of this application. For details not disclosed in the apparatus embodiments of this application, refer to the method embodiments of this application.

FIG. 11 is a block diagram of an apparatus for training an ML model according to an embodiment of this application. The apparatus has a function of implementing the foregoing method examples. The function may be implemented by hardware or by hardware executing corresponding software. The apparatus may be the foregoing terminal device, or may be disposed in the terminal device. As shown in FIG. 11, the apparatus 1100 may include: a first obtaining module 1110, a classification module 1120, and a training module 1130.

The first obtaining module 1110 is configured to obtain classification reference information of a target ML model.

The classification module 1120 is configured to determine a type of the ML model according to the classification reference information.

The training module 1130 is configured to: train, when the type of the ML model is a first type, the ML model by using a first parallelism strategy, the first parallelism strategy being a hybrid strategy of a model parallelism manner and a data parallelism manner; or train, when the type of the ML model is a second type, the ML model by using a second parallelism strategy, the second parallelism strategy being a strategy of a data parallelism manner, the model parallelism manner being a manner of segmenting a same neural network layer of the ML model to at least two nodes for training, and the data parallelism manner being a manner of allocating different training samples of the ML model to at least two nodes for training.

In some embodiments, when the type of the ML model is the first type, the ML model includes: a first neural network layer using the model parallelism manner, and a second neural network layer using the data parallelism manner.

In some embodiments, input data of the first neural network layer includes first input feature information corresponding to each of M₁ training samples, output data of the first neural network layer includes first output feature information corresponding to each of the M₁ training samples, input data of the second neural network layer includes second input feature information corresponding to each of the M₁ training samples, output data of the second neural network layer includes second output feature information corresponding to each of the M₁ training samples, and M₁ is an integer greater than 1.

In some embodiments, the training module 1120 is further configured to: for the first neural network layer, segment the first neural network layer into N₁ segments and synchronize network parameters of the N₁ segments to N₁ nodes, where an i^{th} node in the N₁ nodes stores a network parameter of an i^{th} segment in the N₁ segments, N₁ is an integer greater than 1, and i is a positive integer less than or equal to N₁; for the i^{th} node, process the first input feature information corresponding to each of the M₁ training samples through the i^{th} segment, to obtain an i^{th} feature component corresponding to each of the M₁ training samples, where M₁ is an integer greater than 1; and aggregate N₁ feature components corresponding to each of the M₁ training samples, to obtain the first output feature information corresponding to each of the M₁ training samples; for the second neural network layer, synchronize network parameters of the second neural network layer to N₂ nodes, and divide the M₁ training samples into N₂ sample sets, where each sample set includes at least one training sample, a j^{th} node in the N₂ nodes is configured to process a j^{th} sample set in the N₂ sample sets, N₂ is an integer greater than 1, and j is a positive integer less than or equal to N₂; for the j^{th} node, process second input feature information corresponding to each training sample in the j^{th} sample set through the j^{th} node by using the second neural network layer, to obtain second output feature information corresponding to each training sample in the j^{th} sample set; and aggregate second output feature information corresponding to each of training samples in the N₂ sample sets, to obtain the second output feature information corresponding to each of the M₁ training samples.

In some embodiments, the network parameters of the first neural network layer include network parameters respectively corresponding to a plurality of features. the training module 1130 is further configured to: process the network parameters respectively corresponding to the plurality of features to obtain feature values respectively corresponding to the plurality of features; perform a modulo operation on each of the feature values respectively corresponding to the plurality of features and N₁ to obtain modulus values respectively corresponding to the plurality of features; allocate network parameters corresponding to features of a same modulus value to a same segment, to obtain the network parameters of the N₁ segments; and synchronize the network parameters of the N₁ segments to the N₁ nodes.

In some embodiments, the training module 1130 is further configured to: determine a feature category corresponding to each network parameter of the first neural network layer; allocate network parameters corresponding to a same feature category to a same segment, to obtain the network parameters of the N₁ segments; and synchronize the network parameters of the N₁ segments to the N₁ nodes.

In some embodiments, the network parameters of the first neural network layer include network parameters respectively corresponding to a plurality of features. the training module 1130 is further configured to: slice, for network parameters with a parameter quantity less than a first threshold in the network parameters respectively corresponding to the plurality of features, the network parameters according to feature categories corresponding to the network parameters, to obtain first network sub-parameters respectively corresponding to the N₁ segments; determine, for network parameters with a parameter quantity greater than or equal to the first threshold in the network parameters respectively corresponding to the plurality of features, feature values of the network parameters; perform a modulo operation on the feature values of the network parameters and N₁, to obtain modulus values of the network parameters; and obtain, according to the modulus values of the network parameters, second network sub-parameters respectively corresponding to the N₁ segments; obtain network parameters of the N₁ segments according to the first network sub-parameters respectively corresponding to the N₁ segments and the second network sub-parameters respectively corresponding to the N₁ segments; and synchronize the network parameters of the N₁ segments to the N₁ nodes.

In some embodiments, the training module 1130 is further configured to: for the j^{th} node, update a network parameter of the j^{th} node according to the second output feature information corresponding to each training sample in the j^{th} sample set, to obtain an updated network parameter of the j^{th} node; synchronize updated network parameters respectively corresponding to the N₂ nodes, to obtain updated network parameters of the second neural network layer; and update the network parameters of the N₁ nodes according to the second output feature information corresponding to each of the M₁ training samples, to obtain updated network parameters respectively corresponding to the N₁ nodes.

In some embodiments, the training module 1130 is further configured to: synchronize network parameters of the ML model to N₃ nodes, and dividing M₂ training samples of the ML model into N₃ sample sets, where each sample set includes at least one training sample, a k^{th} node in the N₃ nodes is configured to process a k^{th} sample set in the N₃ sample sets, N₃ is an integer greater than 1, and k is a positive integer less than or equal to N₃; for the k^{th} node, process, through the k^{th} node, each training sample in the k^{th} sample set by using the ML model, to obtain a prediction result corresponding to each training sample in the k^{th} sample set; and obtain, according to the prediction result corresponding to each training sample in the k^{th} sample set, a parameter adjustment gradient determined by the k^{th} node; aggregate parameter adjustment gradients determined respectively by the N₃ nodes, to obtain a parameter adjustment gradient of the ML model; and adjust the network parameters of the ML model according to the parameter adjustment gradient of the ML model, to obtain the trained ML model.

In some embodiments, the training module 1130 is further configured to: synchronize network parameters of the ML model to N₃ nodes, and dividing M₃ training samples of the ML model into N₄ sample sets, where each sample set includes at least one training sample, N₄ is a times N₃, a p^{th} node in the N₃ nodes is configured to process α sample sets in the N₄ sample sets, N₃ is an integer greater than 1, p is a positive integer less than or equal to N₃, N₄ is an integer greater than 1, and a is an integer greater than 1; for the p^{th} node, process, through the p^{th} node, each training sample in the α sample sets by using the ML model, to obtain a prediction result corresponding to each training sample in the α sample sets; obtain, according to the prediction result corresponding to each training sample in the α sample sets, a parameter adjustment sub-gradients determined by the p^{th} node; accumulate, when a quantity of sample sets processed by the p^{th} node is less than a second threshold, the α parameter adjustment sub-gradients determined by the p^{th} node, to obtain a parameter adjustment gradient determined by the p^{th} node; aggregate, when a quantity of sample sets processed by the p^{th} node reaches the second threshold, parameter adjustment gradients determined respectively by the N₃ nodes, to obtain a parameter adjustment gradient of the ML model; and adjust the network parameters of the ML model according to the parameter adjustment gradient of the ML model, to obtain the trained ML model.

In some embodiments, the classification reference information includes: a structure of the ML model; and the classification module 1120 is further configured to: compute a parameter quantity of the ML model according to the structure of the ML model; determine the type of the ML model as the first type when the parameter quantity of the ML model is greater than or equal to a third threshold; and determine the type of the ML model as the second type when the parameter quantity of the ML model is less than the third threshold.

In some embodiments, the classification reference information includes: an application scenario of the ML model; and the classification module 1120 is further configured to: determine the type of the ML model as the first type when the application scenario of the ML model belongs to a first scenario category; and determine the type of the ML model as the second type when the application scenario of the ML model belongs to a second scenario category, where the first scenario category is different from the second scenario category.

In some embodiments, the ML model is a recommendation model; when the ML model is a fine-ranking model, the type of the ML model is the first type, where the fine-ranking model is configured to accurately sort and score a first plurality of candidate recommendation results; and when the ML model is a coarse-ranking model or a recall model, the type of the ML model is the second type, where the coarse-ranking model is configured to roughly sort and score a second plurality of candidate recommendation results, and the recall model is configured to screen the second plurality of candidate recommendation results from a recommendation dataset.

In some embodiments, the ML model is a recommendation model; the training module 1130 is further configured to: when the ML model is a fine-ranking model, train the ML model by using a first parallelism strategy, where the fine-ranking model is configured to accurately sort and score a first plurality of candidate recommendation results; and when the ML model is a coarse-ranking model or a recall model, train the ML model by using a second parallelism strategy, where the coarse-ranking model is configured to roughly sort and score a second plurality of candidate recommendation results, and the recall model is configured to screen the second plurality of candidate recommendation results from a recommendation dataset.

In some embodiments, model complexity of the first type of ML model is greater than model complexity of the second type of ML model.

According to the technical solution provided in this embodiment of this application, ML models are classified, a first type of ML model is trained in the model parallelism manner, and a second type of ML model is trained in the data parallelism manner, which can satisfy both training for a large model and training for a small model, thereby satisfying horizontal scalability of training performance of different types of models.

FIG. 12 is a block diagram of a content recommendation apparatus according to an embodiment of this application. The apparatus has a function of implementing the foregoing method examples. The function may be implemented by hardware or by hardware executing corresponding software. The apparatus may be the foregoing terminal device, or may be disposed in the terminal device. As shown in FIG. 12, the apparatus 1200 may include: a second obtaining module 1210, a determining module 1220, and a selection module 1230.

The second obtaining module 1210 is configured to obtain attribute feature information of a target object and attribute feature information of a plurality of contents.

The determining module 1220 is configured to determine, by using a recommendation model, a recommendation score of each of the contents according to the attribute feature information of the target object and the attribute feature information of each of the contents.

The selection module 1230 is configured to select, from the plurality of contents according to the recommendation score of each of the contents, at least one target content recommended to the target object.

The recommendation model is obtained by determining, according to classification reference information of the recommendation model, whether to perform training by using a first parallelism strategy or a second parallelism strategy, the first parallelism strategy is a hybrid strategy of a model parallelism manner and a data parallelism manner, the second parallelism strategy is a strategy of a data parallelism manner, the model parallelism manner is a manner of segmenting a same neural network layer of the ML model to at least two nodes for training, and the data parallelism manner is a manner of allocating different training samples of the ML model to at least two nodes for training.

When the apparatus provided in the foregoing embodiments implements functions of the apparatus, it is illustrated with an example of division of each functional module. In the practical application, the function distribution may be finished by different functional modules according to the actual requirements, that is, the internal structure of the device is divided into different functional modules, to implement all or some of the functions described above.

Specific operation execution manners of the modules in the apparatus in the foregoing embodiment have been described in detail in the embodiment about the method, and details will not be described herein again.

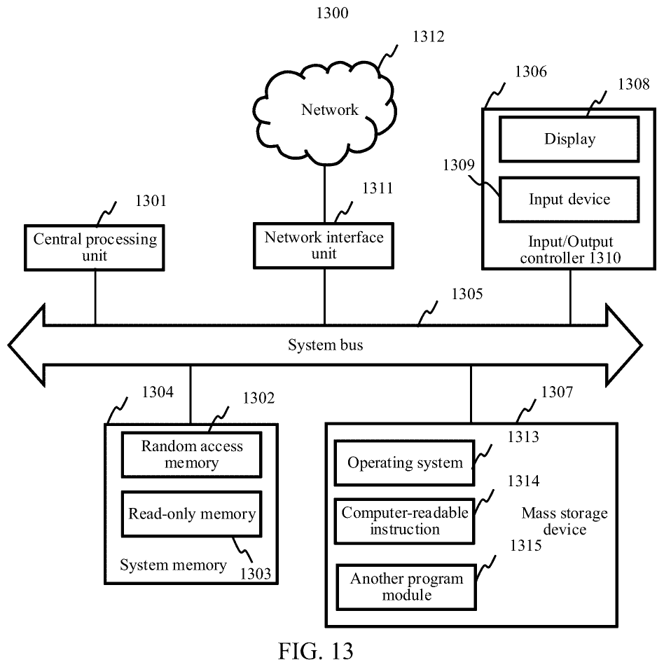

FIG. 13 is a schematic structural diagram of a computer device according to an embodiment of this application. The computer device may be any electronic device with a data computing function, a data processing function, and a data storage function. The computer device may be configured to implement the method for training an ML model provided in the foregoing embodiments or the foregoing content recommendation method. Specifically,

The computer device 1300 includes a central processing unit (for example, Central Processing Unit (CPU), Graphics Processing Unit (GPU), and Field Programmable Gate Array (FPGA)) 1301, a system memory 1304 including a random access memory (RAM) 1302 and a read only memory (ROM) 1303, and a system bus 1305 connecting the system memory 1304 and the central processing unit 1301. The computer device 1300 further includes a basic input/output (I/O) system 1306 assisting in transmitting information between components in a server, and a mass storage device 1307 configured to store an operating system 1311, an application program 1314, and another program module 1315.

In some embodiments, the basic I/O system 1306 includes a display 1308 configured to display information and an input device 1309, such as a mouse or a keyboard, configured to input information for a user. The display 1308 and the input device 1309 are both connected to the CPU 1301 by using an input/output controller 1310 connected to the system bus 1305. The basic I/O system 1306 may further include the I/O controller 1310 configured to receive and process inputs from a plurality of other devices such as a keyboard, a mouse, or an electronic stylus. Similarly, the input/output controller 1310 further provides output to a display screen, a printer, or other types of output devices.

The large-capacity storage device 1307 is connected to the CPU 1301 by using a large-capacity storage controller (not shown) connected to the system bus 1305. The mass storage device 1307 and an associated computer-readable medium provide non-volatile storage for the computer device 1300. That is, the mass storage device 1307 may include a computer-readable medium (not shown) such as a hard disk or a compact disc ROM (CD-ROM) drive.

Without loss of generality, the computer-readable medium may include a computer storage medium and a communication medium. The computer storage medium includes volatile and non-volatile, removable and non-removable media that are configured to store information such as computer-readable instructions, data structures, program modules, or other data and that are implemented by using any method or technology. The computer storage medium includes a RAM, a ROM, an erasable programmable ROM (EPROM), an electrically erasable programmable ROM (EEPROM), a flash memory or another solid-state memory technology, a CD-ROM, a digital versatile disc (DVD) or another optical memory, a tape cartridge, a magnetic cassette, a magnetic disk memory, or another magnetic storage device. Certainly, a person skilled in the art can know that the computer storage medium is not limited to the foregoing several types. The foregoing system memory 1304 and mass storage device 1307 may be collectively referred to as a memory.

According to the embodiments of this application, the computer device 1300 may be further connected, through a network such as the Internet, to a remote computer on the network and run. That is, the computer device 1300 may be connected to a network 1312 by using a network interface unit 1311 connected to the system bus 1305, or may be connected to another type of network or a remote computer system (not shown) by using a network interface unit 1311.

The memory further includes at least one program. The at least one program is stored in the memory and is configured to be executed by one or more processors to implement the foregoing method for training an ML model or the foregoing content recommendation method.

In an exemplary embodiment, a non-transitory computer-readable storage medium is further provided, the storage medium having at least one program stored therein, and the at least one program, when being executed by a processor of a computer device, implementing the foregoing method for training an ML model or the foregoing content recommendation method.

In one embodiment, the computer-readable storage medium may include: a read-only memory (ROM), a RAM, a solid state drive (SSD), an optical disc, or the like. The RAM may include a resistance random access memory (ReRAM) and a dynamic random access memory (DRAM).

In an exemplary embodiment, a computer program is further provided, the computer program includes computer-readable instructions, and the computer-readable instructions are stored in the computer-readable storage medium. The processor of the computer device reads the computer-readable instructions from the computer-readable storage medium, and the processor executes the computer-readable instructions, to cause the computer device to perform the foregoing method for training an ML model.

The user data and signals involved in this application are all authorized by the user or fully authorized by all parties, and the collection, use, and processing of relevant data shall comply with relevant laws, regulations, and standards of relevant countries and regions. For example, the user's attribute feature information involved in this application is obtained with full authorization.

“Plurality of” mentioned in the specification means two or more. The term “and/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

The foregoing descriptions are merely exemplary embodiments of this application, and are not intended to limit this application. Any modification, equivalent replacement, improvement and the like made within the spirit and principle of this application shall fall within the protection scope of this application.

What is claimed is:

1. A method for training a machine learning (ML) model performed by a computer device, the method comprising:
obtaining classification reference information of a target ML model;
determining a type of the ML model according to the classification reference information;
when the type of the ML model is a first type, training the ML model by using a first parallelism strategy, the first parallelism strategy being a hybrid strategy of a model parallelism manner and a data parallelism manner; and
when the type of the ML model is a second type, training the ML model by using a second parallelism strategy, the second parallelism strategy being a strategy of a data parallelism manner,
the model parallelism manner being a manner of segmenting a same neural network layer of the ML model to at least two nodes for training, and the data parallelism manner being a manner of allocating different training samples of the ML model to at least two nodes for training.

2. The method according to claim 1, wherein when the type of the ML model is the first type, the ML model comprises: a first neural network layer using the model parallelism manner, and a second neural network layer using the data parallelism manner.

3. The method according to claim 2, wherein input data of the first neural network layer comprises first input feature information corresponding to each of M₁ training samples, output data of the first neural network layer comprises first output feature information corresponding to each of the M₁ training samples, input data of the second neural network layer comprises second input feature information corresponding to each of the M₁ training samples, output data of the second neural network layer comprises second output feature information corresponding to each of the M₁ training samples, and M₁ is an integer greater than 1; and
the training the ML model by using a first parallelism strategy comprises:
for the first neural network layer, segmenting the first neural network layer into N₁ segments and synchronizing network parameters of the N₁ segments to N₁ nodes, wherein an i^{th} node in the N₁ nodes stores a network parameter of an i^{th} segment in the N₁ segments, N₁ is an integer greater than 1, and i is a positive integer less than or equal to N₁;
for the i^{th} node, processing the first input feature information corresponding to each of the M₁ training samples through the i^{th} segment, to obtain an i^{th} feature component corresponding to each of the M₁ training samples, wherein M₁ is an integer greater than 1;
aggregating N₁ feature components corresponding to each of the M₁ training samples, to obtain the first output feature information corresponding to each of the M₁ training samples;
for the second neural network layer, synchronizing network parameters of the second neural network layer to N₂ nodes, and dividing the M₁ training samples into N₂ sample sets, wherein each sample set comprises at least one training sample, a j^{th} node in the N₂ nodes is configured to process a j^{th} sample set in the N₂ sample sets, N₂ is an integer greater than 1, and j is a positive integer less than or equal to N₂;
for the j^{th} node, processing, through the j^{th} node, second input feature information corresponding to each training sample in the j^{th} sample set by using the second neural network layer, to obtain second output feature information corresponding to each training sample in the j^{th} sample set; and
aggregating second output feature information corresponding to each of training samples in the N₂ sample sets, to obtain the second output feature information corresponding to each of the M₁ training samples.

4. The method according to claim 3, wherein the network parameters of the first neural network layer comprise network parameters respectively corresponding to a plurality of features; and
the segmenting the first neural network layer into N₁ segments and synchronizing network parameters of the N₁ segments to N₁ nodes comprises:
processing the network parameters respectively corresponding to the plurality of features to obtain feature values respectively corresponding to the plurality of features;
performing a modulo operation on each of the feature values respectively corresponding to the plurality of features and N₁ to obtain modulus values respectively corresponding to the plurality of features;
allocating network parameters corresponding to features of a same modulus value to a same segment, to obtain the network parameters of the N₁ segments; and
synchronizing the network parameters of the N₁ segments to the N₁ nodes.

5. The method according to claim 3, wherein the segmenting the first neural network layer into N₁ segments and synchronizing network parameters of the N₁ segments to N₁ nodes comprises:
determining a feature category corresponding to each network parameter of the first neural network layer;
allocating network parameters corresponding to a same feature category to a same segment, to obtain the network parameters of the N₁ segments; and
synchronizing the network parameters of the N₁ segments to the N₁ nodes.

6. The method according to claim 3, wherein the network parameters of the first neural network layer comprise network parameters respectively corresponding to a plurality of features; and
the segmenting the first neural network layer into N₁ segments and synchronizing network parameters of the N₁ segments to N₁ nodes comprises:
slicing, for network parameters with a parameter quantity less than a first threshold in the network parameters respectively corresponding to the plurality of features, the network parameters according to feature categories corresponding to the network parameters, to obtain first network sub-parameters respectively corresponding to the N₁ segments;
determining, for network parameters with a parameter quantity greater than or equal to the first threshold in the network parameters respectively corresponding to the plurality of features, feature values of the network parameters; performing a modulo operation on the feature values of the network parameters and N₁, to obtain modulus values of the network parameters; and obtaining, according to the modulus values of the network parameters, second network sub-parameters respectively corresponding to the N₁ segments;
obtaining network parameters of the N₁ segments according to the first network sub-parameters respectively corresponding to the N₁ segments and the second network sub-parameters respectively corresponding to the N₁ segments; and
synchronizing the network parameters of the N₁ segments to the N₁ nodes.

7. The method according to claim 3, wherein the method further comprises:
updating, for the j^{th} node, a network parameter of the j^{th} node according to the second output feature information corresponding to each training sample in the j^{th} sample set, to obtain an updated network parameter of the j^{th} node;
synchronizing updated network parameters respectively corresponding to the N₂ nodes, to obtain updated network parameters of the second neural network layer; and
updating the network parameters of the N₁ nodes according to the second output feature information corresponding to each of the M₁ training samples, to obtain updated network parameters respectively corresponding to the N₁ nodes.

8. The method according to claim 1, wherein the training the ML model by using a second parallelism strategy comprises:
synchronizing network parameters of the ML model to N₃ nodes, and dividing M₂ training samples of the ML model into N₃ sample sets, wherein each sample set comprises at least one training sample, a k^{th} node in the N₃ nodes is configured to process a k^{th} sample set in the N₃ sample sets, N₃ is an integer greater than 1, and k is a positive integer less than or equal to N₃;
for the k^{th} node, processing, through the k^{th} node, each training sample in the k^{th} sample set by using the ML model, to obtain a prediction result corresponding to each training sample in the k^{th} sample set; and obtaining, according to the prediction result corresponding to each training sample in the k^{th} sample set, a parameter adjustment gradient determined by the k^{th} node;
aggregating parameter adjustment gradients determined respectively by the N₃ nodes, to obtain a parameter adjustment gradient of the ML model; and
adjusting the network parameters of the ML model according to the parameter adjustment gradient of the ML model, to obtain the trained ML model.

9. The method according to claim 1, wherein the training the ML model by using a second parallelism strategy comprises:
synchronizing network parameters of the ML model to N₃ nodes, and dividing M₃ training samples of the ML model into N₄ sample sets, wherein each sample set comprises at least one training sample, N₄ is a times N₃, a p^{th} node in the N₃ nodes is configured to process α sample sets in the N₄ sample sets, N₃ is an integer greater than 1, p is a positive integer less than or equal to N₃, N₄ is an integer greater than 1, and a is an integer greater than 1;
for the p^{th} node, processing, through the p^{th} node, each training sample in the α sample sets by using the ML model, to obtain a prediction result corresponding to each training sample in the α sample sets; obtaining, according to the prediction result corresponding to each training sample in the α sample sets, a parameter adjustment sub-gradients determined by the p^{th} node;
accumulating, when a quantity of sample sets processed by the p^{th} node is less than a second threshold, the α parameter adjustment sub-gradients determined by the p^{th} node, to obtain a parameter adjustment gradient determined by the p^{th} node;
aggregating, when a quantity of sample sets processed by the p^{th} node reaches the second threshold, parameter adjustment gradients determined respectively by the N₃ nodes, to obtain a parameter adjustment gradient of the ML model; and
adjusting the network parameters of the ML model according to the parameter adjustment gradient of the ML model, to obtain the trained ML model.

10. The method according to claim 1, wherein the classification reference information comprises: a structure of the ML model; and
the determining a type of the ML model according to the classification reference information comprises:
computing a parameter quantity of the ML model according to the structure of the ML model;
determining the type of the ML model as the first type when the parameter quantity of the ML model is greater than or equal to a third threshold; and
determining the type of the ML model as the second type when the parameter quantity of the ML model is less than the third threshold.

11. The method according to claim 1, wherein the classification reference information comprises: an application scenario of the ML model; and
the determining a type of the ML model according to the classification reference information comprises:
determining the type of the ML model as the first type when the application scenario of the ML model belongs to a first scenario category; and
determining the type of the ML model as the second type when the application scenario of the ML model belongs to a second scenario category,
wherein the first scenario category is different from the second scenario category.

12. The method according to claim 1, wherein the ML model is a recommendation model;
when the ML model is a fine-ranking model, the type of the ML model is the first type, wherein the fine-ranking model is configured to accurately sort and score a first plurality of candidate recommendation results; and
when the ML model is a coarse-ranking model or a recall model, the type of the ML model is the second type, wherein the coarse-ranking model is configured to roughly sort and score a second plurality of candidate recommendation results, and the recall model is configured to screen the second plurality of candidate recommendation results from a recommendation dataset.

13. The method according to claim 1, wherein model complexity of the first type of ML model is greater than model complexity of the second type of ML model.

14. A computer device, comprising a processor and a memory, the memory having computer-readable instructions stored therein, the computer-readable instructions, when executed by the processor, causing the computer device to implement a method for training a machine learning (ML) model including:
obtaining classification reference information of a target ML model;
determining a type of the ML model according to the classification reference information;
when the type of the ML model is a first type, training the ML model by using a first parallelism strategy, the first parallelism strategy being a hybrid strategy of a model parallelism manner and a data parallelism manner; and
when the type of the ML model is a second type, training the ML model by using a second parallelism strategy, the second parallelism strategy being a strategy of a data parallelism manner,
the model parallelism manner being a manner of segmenting a same neural network layer of the ML model to at least two nodes for training, and the data parallelism manner being a manner of allocating different training samples of the ML model to at least two nodes for training.

15. The computer device according to claim 14, wherein when the type of the ML model is the first type, the ML model comprises: a first neural network layer using the model parallelism manner, and a second neural network layer using the data parallelism manner.

16. The computer device according to claim 14, wherein the classification reference information comprises: a structure of the ML model; and
the determining a type of the ML model according to the classification reference information comprises:
computing a parameter quantity of the ML model according to the structure of the ML model;
determining the type of the ML model as the first type when the parameter quantity of the ML model is greater than or equal to a third threshold; and
determining the type of the ML model as the second type when the parameter quantity of the ML model is less than the third threshold.

17. The computer device according to claim 14, wherein the classification reference information comprises: an application scenario of the ML model; and
the determining a type of the ML model according to the classification reference information comprises:
determining the type of the ML model as the first type when the application scenario of the ML model belongs to a first scenario category; and
determining the type of the ML model as the second type when the application scenario of the ML model belongs to a second scenario category,
wherein the first scenario category is different from the second scenario category.

18. The computer device according to claim 14, wherein the ML model is a recommendation model;
when the ML model is a fine-ranking model, the type of the ML model is the first type, wherein the fine-ranking model is configured to accurately sort and score a first plurality of candidate recommendation results; and
when the ML model is a coarse-ranking model or a recall model, the type of the ML model is the second type, wherein the coarse-ranking model is configured to roughly sort and score a second plurality of candidate recommendation results, and the recall model is configured to screen the second plurality of candidate recommendation results from a recommendation dataset.

19. The computer device according to claim 14, wherein model complexity of the first type of ML model is greater than model complexity of the second type of ML model.

20. A non-transitory computer-readable storage medium, having computer-readable instructions stored therein, the computer-readable instructions, when executed by a processor of a computer device, causing the computer device to implement a method for training a machine learning (ML) model including:
obtaining classification reference information of a target ML model;
determining a type of the ML model according to the classification reference information;
when the type of the ML model is a first type, training the ML model by using a first parallelism strategy, the first parallelism strategy being a hybrid strategy of a model parallelism manner and a data parallelism manner; and
when the type of the ML model is a second type, training the ML model by using a second parallelism strategy, the second parallelism strategy being a strategy of a data parallelism manner,
the model parallelism manner being a manner of segmenting a same neural network layer of the ML model to at least two nodes for training, and the data parallelism manner being a manner of allocating different training samples of the ML model to at least two nodes for training.
